(19) United States
(12) Patent Application Publication
(10) Pub. No.: US 2008/0259937 A1
(43) Pub. Date: Oct. 23, 2008

(54) Circuit Arrangement and Method for the Analysis of a Network

(75) Inventors: Georg Hagenauer, Bad Aibling (DE); Ronald Marten, Munchen (DE); Johannes Nuhrenberg, Riemerling (DE); Wolfgang Swegat, Villach (AT)

Correspondence Address: BELL, BOYD & LLOYD, LLP, P.O. BOX 1135, CHICAGO, IL, 60690, US

(73) Assignee: Siemens Aktiengesellschaft, Munchen (DE)

(21) Appl. No.: 11/660,245

(22) PCT Filed: Aug. 3, 2005
(86) PCT No.: PCT/EP2005/053814

§ 371 Date: Mar. 20, 2008

(30) Foreign Application Priority Data
Aug. 19, 2004 (DE) 10 2004 040 303.1

(51) Int. Cl. H04L 12/28

(52) U.S. Cl. 370/400

(57) ABSTRACT

According to one aspect a network analyzer is configured such that destination addresses are allocated to measured quality-of-service values in network transfer units. Addresses of network nodes which do not meet the expected quality of service values are determined in a central network management system. An adequate quality-of-service can be maintained in the network by isolating the network nodes.

### CROSS REFERENCE TO RELATED APPLICATIONS

This application is the US National Stage of International Application No. PCT/EP2005/053814, filed Aug. 3, 2005 and claims the benefit thereof. The International Application claims the benefits of German application No. 102004040303.1 DE filed Aug. 19, 2004, both of the applications are incorporated by reference herein in their entirety.

### FIELD OF INVENTION

The present invention relates to a circuit arrangement and method for the analysis of a network.

### BACKGROUND OF INVENTION

The continuing integration of data, such as voice data and data files, which has previously been transmitted in communications networks separately increasingly requires a communications technology that can cross network boundaries. Alongside the realtime-capable circuit-switched networks LVN that have traditionally been used, increasing use is being made for voice services and voiceband data transmission of non-realtime-capable packet-switched networks PVN, which were previously intended for pure data transmissions. In contrast to packet-switched networks PVN, in circuit-switched networks LVN, one channel is switched exclusively for the transmission of information. This channel satisfies the real-time characteristics required for voice services and voiceband data transmission. As part of this integration, services previously operated exclusively between end points in circuit-switched networks LVN are handled both via packet-switched network sections and across network boundaries between LVN and PVN end points. A network transfer unit, a gateway G, is integrated for this purpose at the transition between the two network types, i.e. on the periphery of the packet-switched network PVN. A gateway G generally provides a conversion and/or code-conversion function between the heterogeneous network types. For data streams originating in a circuit-switched network LVN, a gateway G has the function of packet-assembling said data streams and delivering the packet-assembled traffic to the packet-switched network PVN. For data streams originating in packet-switched networks PVN, the functionality is passed through in reverse.

Because data transmission in PVNs is not realtime-capable, a deterioration in data transmission quality can occur. The reason for this is essentially that no transmission channel is exclusively available for individual connections or that one transmission channel is available for all connections. Besides the advantage of improved utilization of the capacity of the transmission channel, this brings with it the disadvantage that the data of different connections is, owing to a high workload or the failure of network sections, subject to various disturbances which severely affect the real-time characteristics of a connection. For example, the transit time of packets may be prolonged. The packet transit time is measured by the ‘packet delay’, as it is known. Furthermore, the time interval between the arrival of consecutive packets may vary greatly. These differences in runtime are measured by the ‘packet jitter’. During data transmission, packets can also be discarded. The proportion of discarded packets is measured by the ‘packet loss’. A marked variance in these three quality criteria leads to a significant deterioration in data transmission. In order to be able to offer real-time services with predetermined quality criteria in the PVN, the parameters must move only within defined limits.

### SUMMARY OF INVENTION

An object of the invention is to indicate a further circuit arrangement and an associated method for the analysis of a network.

The object is achieved by the features of the independent claims.

The invention brings with it the advantage that quality problems within a packet-switched network PVN can be detected without additional special protocols or specialized network architectures and substitute paths provided.

The invention brings with it the advantage that within a data-packet-switching network PVN the network nodes and network regions responsible for the deterioration in data transmission quality can be isolated.

The invention brings with it the advantage that the flow of data can be routed via different nodes within the packet-switched network PVN so as to maintain a warranted quality of data transmission.

The invention brings with it the advantage that the inclusion of intact network routes enables an efficient analysis and isolation of overloaded or failed network sections.

### BRIEF DESCRIPTION OF THE DRAWINGS

Further special features of the invention will become evident from the detailed explanations below in relation to the figures showing an exemplary embodiment, wherein:

FIG. 1 shows a schematic network representation of an IP-based data transmission network comprising network transfer units,

FIG. 2 shows an isolation of a network node within the IP-based data transmission network,

FIG. 3 shows a flow diagram regarding the determination of address-data records and

FIG. 4 shows a further flow diagram regarding the analysis of the data records.

### DETAILED DESCRIPTION OF INVENTION

The sections below describe the application of the invention to an IP-based telecommunications network.

The gateways G arranged on the periphery of the IP networks, which gateways are also referred to hereinbelow as media gateways, are for example access gateways or trunking gateways.

As a special form of media gateway, an access gateway enables on the one hand the connection of traditional analog subscriber-network interfaces and on the other the connection of common digital subscriber-network interfaces, user-network interfaces (UNI) as they are called, to an Internet-Protocol-based network IPN. Examples of the latter connections are an ISDN basic-rate interface or ISDN primary-rate interface.

As a further embodiment of a media gateway G, a trunking gateway enables the connection of common network-network interfaces (NNI), i.e. network-internal interfaces such as e.g. SS7 signaling and trunks. A trunking gateway is located at a network-internal interface between classic circuit-switched networks and Internet-Protocol-based networks IPN.

A standard of data transmission, as explained above, that is to be maintained within the networks with Internet Protocol is called a quality of service QoS. To determine the QoS in the Internet-Protocol-based network IPN, measurements for checking the quality criteria ‘packet delay’, ‘packet jitter’ and ‘packet loss’ are carried out and compiled in parallel with the transmission of data. Here, ‘packet delay’ evaluates the transit time of a data packet, ‘packet jitter’ the time interval between the receipt by the recipient of packets that were originally consecutive and ‘packet loss’ the proportion of packets which are lost during data transportation between a data source and a data sink in the Internet-Protocol-based network IPN.

Depending on the density of data traffic, individual network elements, e.g. routers, may become overloaded. The density of data may vary e.g. with the time of day or intensify significantly as a result of the failure of a network element, e.g., a router. As a result of the overloading, the routers concerned increasingly start to discard IP packets and latency times rise and/or vary greatly for different packets in a data stream. As a consequence of this, a QoS guaranteed to the user may no longer be maintained.

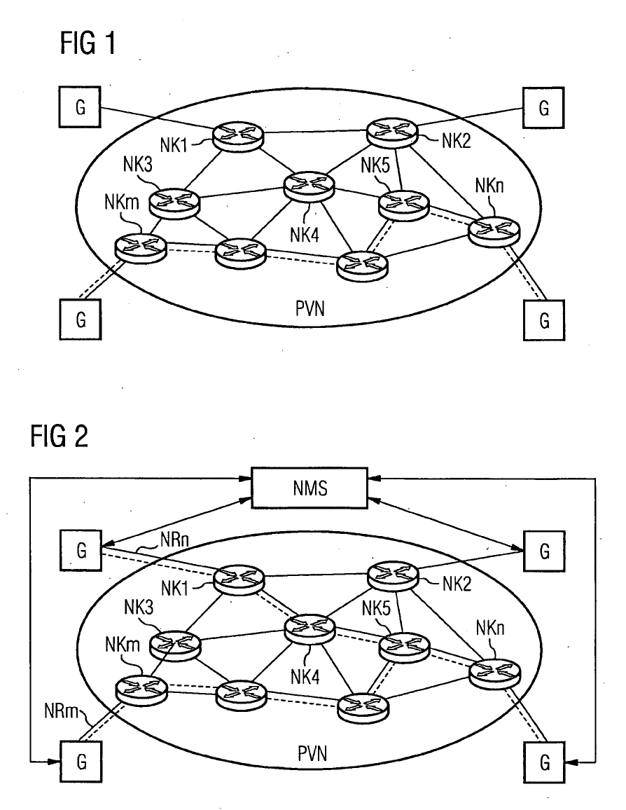

FIG. 1 shows schematically a large number of network nodes NK1, . . . , NKn, also referred to hereinbelow as routers, within an Internet-Protocol-based network IPN. The routers NK1, . . . , NKn are intermeshed with one another. Access to the Internet-Protocol-based network IPN exists e.g. via media gateways G. Said media gateways G exist, as explained above, in different designs.

The subject matter of the invention and the associated method will be described with the aid of FIG. 2.

According to the invention, a decline in the quality of service QoS is detected and eliminated in respect of existing connections and prevented in respect of new connections in accordance with the following steps. The access gateways or trunking gateways arranged on the periphery of the Internet-Protocol-based network IPN continuously measure the QoS parameters such as ‘packet delay’, ‘packet jitter’ and ‘packet loss’. This data is analyzed within a time interval specified by the network management system NMS in a destination-IP-address-oriented manner, i.e. the QoS parameters of a plurality of connections to the same destination IP address are aggregated.

The network operator specifies via a network management system NMS the quality of service warranted to the user and to be provided by the system. The destination IP addresses of a data connection with a degraded QoS are firstly logged in the access gateways or trunking gateways in the destination-address-determining module ZAM. In addition, the network routes NR of a few destination IP addresses with a non-degraded QoS are also determined.

For the destination IP addresses with a degraded and a non-degraded QoS, both the destination IP addresses and the transit IP addresses of the network nodes NK1, . . . , NKn along the data connection path are determined in the gateways in the transit-network-node-determining module TEM. The latter is carried out using a network-route-determining method NREV. The basic function of an NREV is explained below with the aid of the trace-route method:

The trace-route method represents a standard method which is available e.g. on UNIX-based systems as a command-line instruction for determining and logging the route of packets to dedicated IP addresses. In the media gateway, this standard method is simulated in order to determine the transit IP addresses for a destination IP address with a degraded or a non-degraded QoS. In the trace-route method, packets which are discarded in the transit network nodes, concerning which the media gateway is informed, are transmitted by the media gateway in a targeted manner. The acknowledgement sent to the media gateway identifies the IP address of the transit network node. The IP addresses of all the transit network nodes to one destination IP address are referred to as a network route NR.

The network routes NR which are determined of the destination IP addresses which are classified as having an inadequate QoS, as well as a number of network routes NR of the destination IP addresses with an adequate QoS, are forwarded at regular intervals by the media gateway via the data-providing module DBM to a network management system NMS.

The quality-of-service problems are then analyzed in the network management system NMS. Not only is the data of one media gateway but that of all media gateways of the Internet-Protocol-based network IPN available to the network management system NMS as the central network element for this purpose. This enables a comprehensive examination of the entire IPN. The network routes NR with a quality-of-service QoS problem are correlated in the analysis with the network routes NR classified as ‘good’. Through this correlation of the measurement data of all the media gateways, faulty network elements, e.g. transit network nodes or line sections between transit network nodes, are identified. By also examining the network routes NR with an adequate QoS, the number of possible causers of an inadequate QoS is drastically reduced. As a response, targeted rerouting can be carried out, by means of which a faulty network route section can be bypassed or a poor transit network node NKn isolated. Subsequent connections are then rerouted to intact network route sections.

In one variant, the transmission of telecommunications data between the time-division-multiplex network, which is also referred to as a circuit-switched network LVN, and the Internet-Protocol-based network IPN is implemented within an access gateway by means of a modem pool card, for example. During a measurement cycle specified by the network management system NMS a destination-IP-address-specific measurement is carried out with regard to the quality-of-service parameters. In the process, a destination IP address is adopted into a list of destination IP addresses with an unachieved quality-of-service value unless the upper limit specified by the network management system NMS was achieved for one of the significant quality-of-service parameters. The measurements of different connections to the same destination IP address are collected over the duration of a measurement cycle in the media gateway G and examined together. For each destination IP address with a degraded QoS value and for a few with a non-degraded QoS value the network route NR, i.e. the list of the IP addresses of all the transit network nodes to the respective destination IP address, is then determined with the aid of a network-route-determining method NREV such as e.g. the trace-route method.

At the end of each measurement cycle, both the list of destination IP addresses with a degraded quality-of-service value QoS, including their determined network routes NR, and the selected destination IP addresses with a non-degraded quality-of-service value QoS are, together with their associated network routes NR, made available to the network management system NMS in the form of a file. The network analysis can be triggered in various ways. Thus, depending on a suitable alarm mechanism, the data determined can be actively transferred from the media gateway G to the network management system NMS. Alternatively, the NMS can conversely fetch this data periodically from the media gateway via a polling mechanism. Based upon the data collected in the network management system NMS, a transit network node NKn can, with the aid of post-processing in the NMS that analyzes the network routes NR determined, provisionally be taken from the Internet-Protocol-based network IPN.

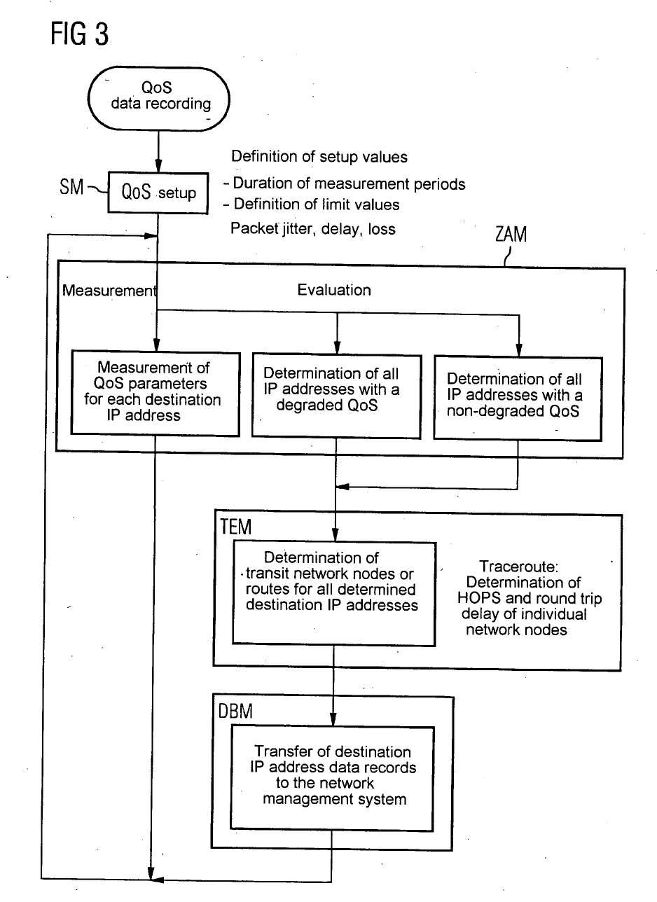

FIG. 3 shows a flow diagram relating to the capture of the QoS data. The evaluation and network analysis combined in modules is preferably arranged in media or access gateways. Also, the duration of the measurement period and the specification of maximum values for jitter, delay and loss can be defined by means of a setup module SM. The QoS parameters are measured for each destination IP address. In this measurement, as indicated above, all destination IP addresses with a degraded QoS and all destination IP addresses with a non-degraded QoS are continuously determined in the destination-address-determining module ZAM. Based upon the data available, the routes for all the destination IP addresses determined with a degraded QoS and likewise for some with a non-degraded QoS are then determined in a subsequent transit-network-node-determining module TEM. The route data is forwarded by a data-providing module DBM to network management for further processing.

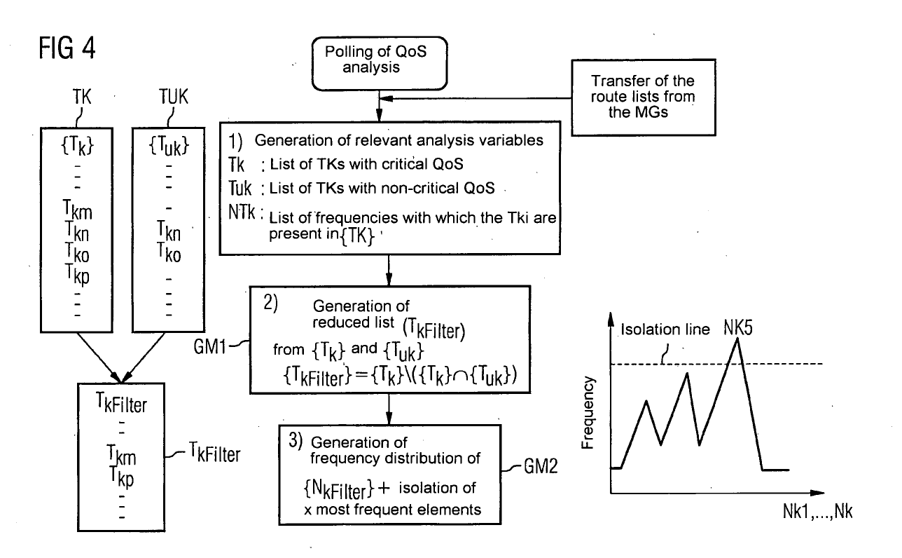

FIG. 4 indicates a flow diagram relating to the evaluation of the QoS data. The data generated by means of the data-providing modules of the individual media gateways G is collated in a first, second and third list Tₖ, Tᵤₖ, N_{TK} in a storage unit in the network management unit NMS. The first list Tₖ contains all the transit nodes which occur in routes with a critical QoS and the second list Tᵤₖ those transit nodes which occur in the selected routes with a non-critical QoS. Finally, list N_{TK} contains the frequencies with which the elements occur in the list Tₖ. By means of a first generating module GM1, the set of all transit network nodes with a potentially critical QoS Tₖ is reduced by the elements which are also contained in the list of transit network nodes with a non-critical QoS Tᵤₖ. The result is compiled in a fourth list T_{kFilter}. By means of a second generating module GM2, the remaining potential causer nodes in the list T_{kFilter} are set in relation to the frequencies in the third list N_{TK}. In a concluding analysis, the actual causers are isolated in GM2 using a criterion specified by the network management system. See in this regard the frequency distribution of critical transit network nodes NKn.

1.-9. (canceled)

10. A circuit arrangement for an analysis of a network having a packet-switched network including a plurality of network nodes and a network transfer unit that enables a transfer to a superordinate network management system that handles network management tasks and to a circuit-switched network, comprising:
a destination-address-determining module that determines:
a first destination address associated with a degraded quality-of-service, and
a second destination address associated with a non-degraded quality-of-service;
a transit-network-node-determining module that determines:
a first transit address of a first transit network node associated with a route for the first data address, and
a second transit address of a second transit network node associated with a route for the second data address; and
a data-providing module that forwards:
the first transit address associated with the route associated with the degraded quality-of-service, and
the second transit address associated with the route associated with the non-degraded quality-of-service system
to the network management system for the determination of transit network nodes that do not satisfy a quality-of-service criteria stipulated by an operator.

11. The circuit arrangement as claimed in claim 10, wherein the network management system includes:
a first list of potential transit network nodes with a critical quality-of-service value,
a second list of transit network nodes with destination address with a non-critical quality-of-service value, and
a third list having a frequency with which each element occurs in the first list.

12. The circuit arrangement as claimed in claim 11, wherein the network management system includes a first generating module that generates a third list as a subset of the first list by reducing a number of the potential transit network nodes in the first list based on the transit network nodes in the second list.

13. The circuit arrangement as claimed in claim 12,
wherein the network management includes a second generating module to generate a fourth list, the second generating module uses the frequency of the elements in the first list within the third list set in relation to a remaining potential causer transit network node of the fourth list, and
wherein by specifying an isolation criterion, the transit network node in the fourth list is provisionally blocked from transmitting data within the communication network.

14. The circuit arrangement as claimed in claim 11, wherein the network transfer unit is a gateway and the destination-address-determining module, the transit-network-node-determining and the data-providing module are arranged in the gateway.

15. The circuit arrangement as claimed in claim 14,
wherein a plurality of gateways each including the destination-address-determining module, the transit-network-node-determining and the data-providing module are arranged in the network and transfer the first and second transit addresses to the network management system, and
wherein the network management system uses the transferred addresses to isolate a network node responsible for the deterioration in the data transmission quality.

16. The circuit arrangement as claimed in claim 15, wherein a new connection is rerouted to avoid the isolated network node.

17. A circuit arrangement for an analysis of a network, comprising:
a packet-switched network including a plurality of network nodes; and
a gateway that enables a transfer to a superordinate network management system that handles network management tasks and to a circuit-switched network, the gateway comprising:
a destination-address-determining module that determines:
a first destination address associated with a degraded quality-of-service, and
a second destination address associated with a non-degraded quality-of-service;
a transit-network-node-determining module that determines:
a first transit address of a first transit network node associated with a connection path for the first data address, and
a second transit address of a second transit network node associated with a connection path for the second data address; and
a data-providing module that forwards:
the first transit address associated with the connection path associated with the degraded quality-of-service, and
the second transit address associated with the connection path associated with the non-degraded quality-of-service system
to the network management system for the determination of a connection path that does not satisfy a quality-of-service criteria.

18. The circuit arrangement as claimed in claim 17 wherein the network management system includes:
a first list of potential transit network nodes with a critical quality-of-service value,
a second list of transit network nodes with destination address with a non-critical quality-of-service value, and
a third list having a frequency with which each element occurs in the first list.

19. The circuit arrangement as claimed in claim 18, wherein the network management system includes a first generating module that generates a third list as a subset of the first list by reducing a number of the potential transit network nodes in the first list based on the transit network nodes in the second list.

20. The circuit arrangement as claimed in claim 19,
wherein the network management includes a second generating module that generates a fourth list, the second generating module uses the frequency of the elements in the first list within the third list set in relation to a remaining potential causer transit network node of the fourth list, and
wherein by specifying an isolation criterion, the transit node of the fourth list is provisionally blocked from transmitting data within the communication network.

21. The circuit arrangement as claimed in claim 18, wherein the network transfer unit is a gateway and the destination-address-determining module, the transit-network-node-determining and the data-providing module are arranged in the gateway.

22. The circuit arrangement as claimed in claim 21,
wherein a plurality of gateways including the destination-address-determining module, the transit-network-node-determining and the data-providing module are arranged in the network and transfer the first and second transit addresses to the network management system, and
wherein the network management system uses the transferred addresses to isolate a network node responsible for the deterioration in the data transmission quality.

23. The circuit arrangement as claimed in claim 22, wherein subsequent connections are rerouted to avoid the isolated network node.

24. A method for the analysis of a network, having a packet-switched network having a plurality of network nodes and a network transfer unit that enables a transfer to a circuit-switched network and enables a transfer to a superordinate network management system that handles network management tasks, the method comprising:
determining a destination addresses associated with a network route within the packet-switched network;
allocating a quality-of-service value to the destination address;
determining a transit address of a transit network node associated with the network route; and
forwarding the transit address to the network management system for determining a transit network node within the packet-switched network that does not satisfy the quality-of-service criteria stipulated by an operator.

25. The method as claimed in claim 24, further comprises providing a first list a set of potential transit network nodes with a critical quality-of-service, a second list with transit network nodes with a non-critical quality-of-service value, and a third list a frequency with which the elements in the first list occur.

26. The method as claimed in claim 25, wherein a number of potential transit network nodes from the first list is reduced on the basis of the transit network nodes in the second list to form a fourth list.

27. The method as claimed in claim 26,
wherein a frequency distribution of the elements in the first list within the third list is set in relation to a remaining potential causer transit network nodes of the fourth list, and
wherein, by specifying an isolation criterion, the transit node is provisionally blocked from transmitting data within the communication network.

28. The method as claimed in claim 24, further comprising:
receiving by the network management system a plurality of transit addresses associated with a degraded quality-of service and a plurality of transit addresses associated with a non-degraded quality-of service;
determining from the received addresses a transit node that does not satisfy the quality of service criteria; and
rerouting a new connection to avoid the transit node that does not satisfy the quality of service criteria.
